(19) United States
(12) Patent Application Publication
(10) Pub. No.: US 2025/0141557 A1
(43) Pub. Date: May 1, 2025

(54) PROCESSING OF OPTICAL SIGNALS

(71) Applicant: Adtran Networks SE, Meiningen (DE)

(72) Inventors: Martin Kuipers, Dallgow-Döberitz (DE); Michael Eiselt, Amt Wachsenburg (DE); Gabriele Di Rosa, Munich (DE)

(21) Appl. No.: 18/930,429

(22) Filed: Oct. 29, 2024

(30) Foreign Application Priority Data
Oct. 31, 2023 (EP) 23207182.9

(51) Int. Cl. H04B 10/40; H04B 10/27

(52) U.S. Cl. CPC H04B 10/40; H04B 10/27

(57) ABSTRACT

A solution is provided for processing optical signals, wherein a mixing signal and a transmission carrier are both derived from a single light source, and wherein the mixing signal is located within a frequency band of a received signal and/or wherein the transmission carrier is located within the frequency band of the transmission signal.

### RELATED APPLICATION

This application claims priority to EP Application Number 23207182.9, filed Oct. 31, 2023, the contents of which are hereby incorporated by reference in its entirety.

### BACKGROUND

In a passive optical network (PON), upstream and downstream signals are transported on the same fiber. Their spectral ranges are disjoint to avoid interference from scattering and reflections on the fiber.

### SUMMARY

For coherent signals, it is an objective to use a single optical light source as local oscillator (LO) for the receiver and also as a transmit laser. In addition, it is desirable to have only a small frequency gap between the received signal and the frequency of the local oscillator to limit the bandwidth requirement for the analogue and digital components and to allow for faster frequency and phase locking of burst signals.

Coherent PON systems are at an early stage. A straightforward solution is the use of the upper and lower sidebands of the modulated light signal for upstream and downstream signals (or vice versa). While the frequency bands used for both directions are disjoint, any reflected part of the transmitted signal falls into the bandwidth of the coherent receiver, when the transmit laser is used as local oscillator, and saturate amplifiers and ADCs.

The problem to be solved is to overcome this disadvantage.

This problem is solved according to the features of the independent claims. Further embodiments result from the depending claims.

The examples suggested herein may in particular be based on at least one of the following solutions. In particular, combinations of the following features could be utilized in order to reach a desired result. The features of the method could be combined with any feature(s) of the device or system or vice versa.

In order to overcome this problem, a method is suggested for processing optical signals,
wherein a mixing signal and a transmission carrier are both derived from a single light source,
wherein the mixing signal is located within a frequency band of a received signal and/or wherein the transmission carrier is located within the frequency band of the transmission signal.

In particular, an optical network component, e.g., an OLT or ONU may comprise a transceiver that allows coherent signal processing by utilizing the single light source to define the mixing signal as well as the transmission carrier. The mixing signal may be obtained by a local oscillator (LO) and it may also be referred to as LO signal. The mixing signal has a mixing frequency fₘᵢₓ and the transmission carrier has a transmission frequency f_{TX}.

The light source can be set
to the mixing frequency, then deriving the transmission frequency based on the mixing frequency, or
to the transmission frequency, then deriving the mixing frequency based on the transmission frequency,
anything between the mixing frequency and the transmission frequency, then deriving the mixing frequency and the transmission frequency.

According to an embodiment, the single light source comprises a laser or a laser diode.

It is noted that “single light source” may be understood as a light source supplying light at a single frequency. The at least one additional frequency required is then derived from the single frequency of this light source.

According to an embodiment, the method is operated by an optical transceiver.

According to an embodiment, the mixing signal corresponds to or is based on a local oscillator for receiving signals.

According to an embodiment, the mixing signal and a transmission carrier are separated by a fixed frequency.

Hence the mixing signal and the transmission carrier may be separated by a given spacing, which may in particular be controlled by an electronic oscillator thereby providing a high level of accuracy (e.g., in the MHz range).

According to an embodiment, the received signal is low pass filtered in the electrical domain.

According to an embodiment, the frequency of the transmission carrier is adjusted based on an offset between the frequency of the mixing signal and a center frequency of the received signal.

According to an embodiment, the mixing signal and the transmission carrier are both derived from a single light source utilizing one of the following:
the mixing signal is obtained from the single light source, a frequency shift is obtained by a phase slope modulation over time and the frequency shift is used to determine the transmission carrier;
the mixing signal and the transmission carrier are generated by modulation through a signal with a frequency amounting to a frequency shift Δf or a sub-harmonic thereof;
the mixing signal and the transmission carrier are obtained via an I-Q-modulator utilizing a phase-slope modulation corresponding to half the desired frequency shift value;
the mixing signal and the transmission carrier are obtained via a comb laser structure.

It is noted that the sub-harmonic may in particular comprise a frequency of which an integer multiple amounts to the frequency shift value Δf.

Also, an optical transceiver is provided comprising
a transmitter to transmit optical signals,
a receiver to receive optical signals,
a single light source that is utilized for a mixing signal and a transmission carrier, wherein the mixing signal is located within a frequency band of a received signal and/or wherein the transmission carrier is located within the frequency band of the transmission signal.

According to an embodiment, the transceiver is located in an optical network component, in particular in an OLT or an ONU.

Further, a device for processing optical signals is suggested, comprising a processing unit that is arranged to conduct the steps of the method as described herein.

According to an embodiment, the device is or is part of an optical line terminal or an optical network unit.

In addition, a communication system is provided comprising at least one device as described herein.

Details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an exemplary diagram of a PON comprising an OLT and several ONTs.

FIG. 2 shows a schematic diagram visualizing a carrier frequency of a laser within a gap between a downstream band and an upstream band.

FIG. 3 shows a schematic diagram depicting the downstream band and the upstream band at the OLT (or ONT) with a carrier frequency within a band gap.

FIG. 4A shows an optical spectrum of the upstream signals received at the OLT with a mixing signal in the receiving frequency band.

FIG. 4B shows a diagram of the resulting electrical spectrum based on the optical spectrum shown in FIG. 4A.

FIG. 4C shows an optical spectrum of the downstream signals transmitted from the OLT comprising a transmission carrier that is determined based on the mixing signal shown in FIG. 4A.

### DETAILED DESCRIPTION

Examples described herein refer to placing a mixing signal (also referred to as LO signal) in (or around) the center of the received spectrum and a transmission carrier is derived based on the mixing signal by frequency shifting, in particular shifted by a frequency Δf. In an exemplary embodiment, the frequency Δf can be slightly larger than the bandwidth of the (transmitted or received) signal.

At least one of the transmission carrier or the mixing signal can be determined based on a single light source. The single light source may comprise a laser or a laser diode. The single light source may emit light at a single frequency and the approach described herein utilizes this single frequency to determine the transmission carrier and/or the mixing signal. Also, if the mixing signal is derived first based on the single light source, the transmission carrier may then be determined based on the mixing signal. This applies accordingly the other way round, i.e., first the transmission carrier then the mixing signal.

This approach bears the advantage that the bandwidth required at the receiver (e.g., bandwidth of photo diodes, TIAs and/or ADCs) is reduced. Any reflected signal at frequencies outside the received spectrum can be filtered in the electrical domain (electrical spectrum) and hence avoid unwanted saturation of amplifiers or ADCs.

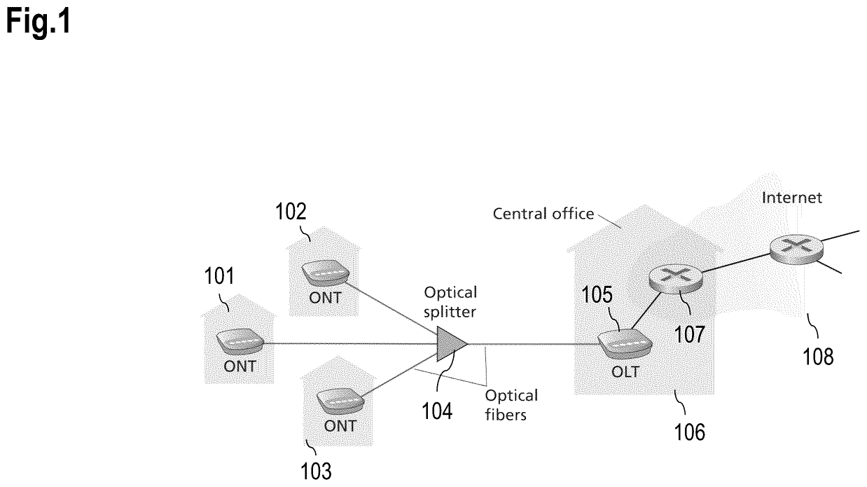

FIG. 1 shows an exemplary diagram of a PON comprising several ONTs 101, 102, 103 that are connected via an optical splitter 104 to an OLT 105 at a CO 106. It is noted that the ONT may also be referred to as ONU. The OLT 105 is further connected via a router 107 to the Internet 108.

In a coherent PON, signals are sent in separate bands from the OLT 105 to the ONTs 101, 102, 103 and from the ONTs 101, 102, 103 to the OLT 105. TDMA can be used as multiplexing technique to convey traffic from/to the ONTs 101, 102, 103.

For coherent reception and transmission, a single laser could be used in the optical components, e.g., ONTs 101 to 103, OLT 105.

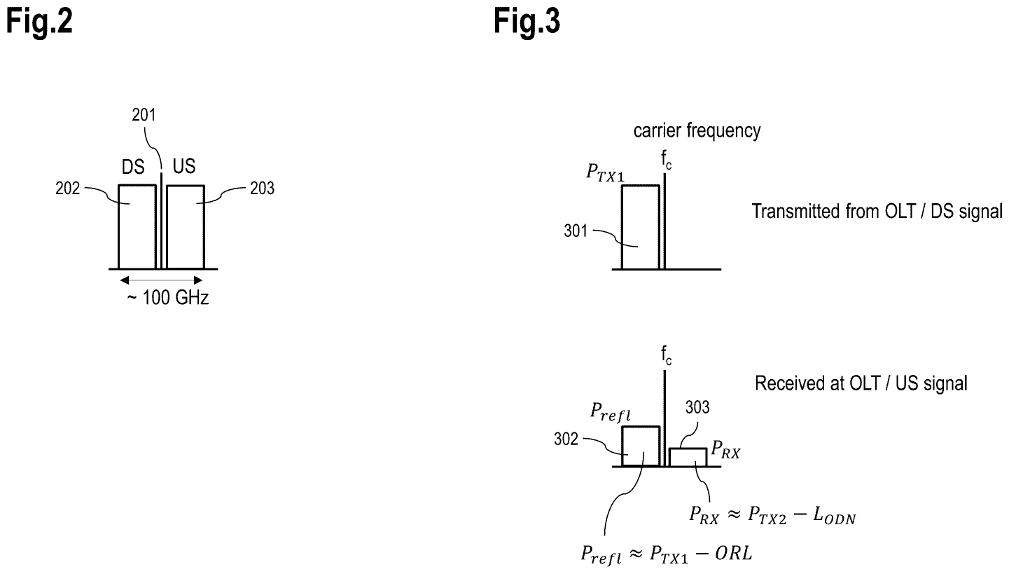

FIG. 2 shows a schematic diagram visualizing a carrier frequency 201 of a laser with a frequency that lies within a gap between a downstream (DS) band 202 and an upstream (US) band 203. Hence, the DS band and the US band are on two side bands of the carrier frequency 201. The overall bi-directional channel bandwidth in this example may amount to ca. 100 GHz.

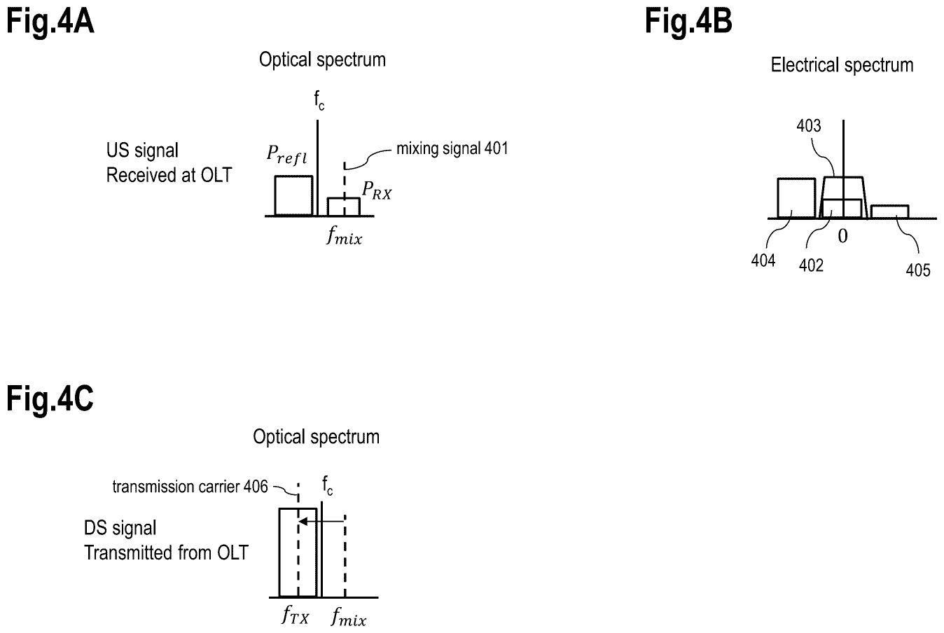

It is noted that the FIG. 2, FIG. 3 as well as FIG. 4A to FIG. 4C show a frequency on the x-axis and a strength of the (frequency) signal on the y-axis.

The OLT 105 determines the central frequency, the ONTs 101, 102, 103 lock to this frequency for the common LO frequency and/or for the transmission carrier.

TDMA is used for multi-user access. However, TFDMA can also be used if side bands are sliced into different sub-bands or sub-carriers.

However, arranging the carrier frequency 201 between the DS band 202 and the US band 203 results in some disadvantages as shown and explained with regard to FIG. 3.

FIG. 3 shows a schematic diagram depicting the DS band and the US band at the OLT (it applies accordingly to each ONT). As indicated above, in a coherent PON, the DS band 202 and the US band 203 use the same carrier frequency 201.

A signal in the DS band at a power P_{TX1} 301 is transmitted from the OLT towards the ONT(s). This signal is (partially) reflected in the optical distribution network (ODN) and/or in the feeder line resulting in a reflected power P_{refl} 302

$${P}_{refl} \approx {P}_{TX 1} - ORL ,$$

in the US band, wherein ORL is the optical return loss.

Also, a (useful) signal is transmitted from the ONT at a power P_{TX2} and received in the US band at the OLT with a power P_{RX} 303, which amounts to

$${P}_{RX} \approx {P}_{TX 2} - {L}_{ODN} ,$$

wherein L_{ODN} is the loss of the ODN.

If

L_{ODN}>ORL,

the reflected transmission power P_{refl} 302 is larger than the received signal power P_{RX}, which significantly limits the reception gain and/or the ADC resolution.

Example: L_{ODN}=35 dB, ORL=24 dB: The interference of the lower side band is 11 dB larger than the received signal (in case P_{TX2}=P_{TX1}).

The interference value also depends on the TX power differences between the OLT and the ONT. Typically, the OLT TX power is larger than the ONT TX power (P_{TX1}>P_{TX2}), which would further increase the interference level.

To overcome the disadvantage of the significant interference of the useful received signal, the frequency of a laser supplying a mixing signal may be set to the center of the receiving band (to receive the US signal), e.g., ca.+25 GHz off a nominal center frequency f_{c}.

The mixing signal could be provided by a local oscillator (LO) or it might be provided from another source. The mixing signal could in particular be a signal supplied by or based on a single light source, e.g., a laser, of the optical network element, e.g., OLT.

FIG. 4A shows an optical spectrum of the US signals received at the OLT comprising the reflected signal with the reflected transmission power P_{refl} 302 and the useful signal from the ONT received with the power P_{RX} 303 as shown in and described with regard to FIG. 3.

Contrary to FIG. 3, the mixing signal 401 with a mixing frequency fₘᵢₓ is located within the frequency band of the receiving band, e.g., 25 GHz off the nominal center frequency f_{c}, i.e.:

$${f}_{mix} = {f}_{c} + 25 GHz .$$

It is noted that the mixing frequency fₘᵢₓ may in particular be set to the center of the receiving band or slightly off center of the receiving band.

FIG. 4B shows a diagram of the resulting electrical spectrum comprising a down-mixed reflected signal 404, a useful signal 402 and an impairment signal 405, which is also based on the reflected power, but emerges due to impairments in the receiver. The useful signal 402 could be filtered by a low-pass characteristics 403 of an amplifier, e.g., a TIA. For example, the TIA could be designed to have a bandwidth of ca. 25 GHz to suppress any of the signals 404 and 405.

FIG. 4C shows an optical spectrum of the DS signals transmitted from the OLT. It is visualized how a transmission carrier 406 at a transmission frequency f_{TX} can be generated from the mixing frequency fₘᵢₓ.

The frequency f_{TX} of the transmission carrier 406 can be coupled to the mixing frequency fₘᵢₓ with a frequency shift amounting to ca. 50 GHz, i.e.:

$${f}_{TX} = {f}_{c} - 25 GHz = {f}_{mix} - 50 GHz .$$

For example, operating the ONT, the mixing frequency fₘᵢₓ could be locked to the received signal (e.g., by thermal tuning), then the frequency f_{TX} is derived from this mixing frequency fₘᵢₓ.

This can be achieved utilizing at least one of the approaches described hereinafter.

How to Determine at Least Two Frequencies (Carriers, Signals) from a Single Light Source:

There are several approaches that can be used to couple the transmission carrier to the mixing signal (LO signal) or vice versa.

For example, the transmission carrier may be derived from a single light source (e.g., laser) that supplies the LO signal by frequency shifting. Also, the LO signal could be derived from the transmission carrier. It is yet an option to derive both (LO signal and transmission carrier) from a single (seed) laser signal, which may operate at a frequency in between the frequency of the LO signal and the frequency of the transmission carrier. Further, a different approach frequency coupling both signals may be chosen.

Hereinafter, a few examples are described in more detail:
(1) The LO signal is obtained as an output from a single-frequency laser, while the frequency shift Δf is obtained by a phase slope modulation in a reset-free phase modulator. A phase modulation with a linear phase increase over time t with

$${ϕ}_{mod} ( t ) = 2 π \cdot Δ f \cdot t$$

results in a frequency shift by a value of Δf. This phase modulation can be applied to the output signal from the single-frequency laser, resulting in an optical carrier shifted by Δf, which can then be used as transmission carrier. A reset-free phase modulator is described in EP 3786689 A1.
(2) According to [Hiroshi Yamazaki, Takashi Saida, Takashi Goh, Atsushi Mori, and Shinji Mino: Dual-carrier IQ modulator with a complementary frequency shifter, Vol. 19, No. 26/OPTICS EXPRESS B69, 12 Dec. 2011], an IQ-modulator can be used, wherein both output branches of an outer Mach-Zehnder structure are used to provide different frequencies. By a phase slope modulation corresponding to Δf/2, the signal frequency is up shifted by Δf/2 at one output port of the modulator and downshifted by Δf/2 at the other output port, such that they can be used as LO signal and as transmission carrier.
(3) Devices of generating comb lasers are described in [Lin Chang, Songtao Liu and John E. Bowers: Integrated optical frequency comb technologies, Nature Photonics, VOL 16, February 2022, pages 95 to 108]. These multiple optical carriers can then be filtered/selected, e.g., by optical filtering, to supply the LO signal and the transmission carrier.

Advantageously, the two frequencies (LO signal and transmission carrier) may be generated by a frequency amounting to Δf or Δf/2 or a sub-harmonic thereof. This frequency can be supplied by an electronic oscillator. A typical accuracy of such an oscillator may be better than 100 ppm (=10⁻⁴). For a frequency shift of 50 GHz, this corresponds to a frequency error smaller than 5 MHz. The center frequency of the signal laser, according to any of the examples (1) to (3) above, or one of the two comb lines, according to example (4), can be locked to an accuracy of about 1 GHz. The same frequency error and error in frequency difference can be assumed from the other side of the link (e.g., OLT). The frequency offset between a transmission carrier of the OLT and a receiver LO signal at an ONU can be derived from the frequency estimation, which is performed in a DSP of the coherent receiver in the ONU. This value can be used two-fold:
It can be used to tune the laser temperature to slightly change the wavelength of the laser.
It can be communicated to the DSP of the ONU transmitter, such that an appropriate phase slope can be added to the modulation to align the center frequency of the transmitted signal to the LO frequency at the OLT to alleviate frequency and phase tracking.

The description above may refer to any network component OLT or ONT. Hence, the examples described with regard to the OLT may be applicable to the ONT accordingly or vice versa.

Looking at the ONU, the offset between the LO signal and the center frequency of the received band can be detected in a DSP handling the reception and it can be adjusted in the transmission modulator. If during the frequency offset estimation, which is a typical function in the receiver DSP sequence, a frequency offset of Δf between the LO signal fₘᵢₓ and a center frequency f_{center} of the received band is determined, i.e.

$$Δ f = {f}_{center} - {f}_{mix} .$$

This value Δf can be used in the transmitter data modulator to shift the transmitted signal center frequency by the same amount. This frequency shift of the transmission frequency can be achieved in the transmitter by phase slope modulation over time. A phase modulation with a linear phase increases over time t with

$${ϕ}_{mod} ( t ) = 2 π \cdot Δ f \cdot t$$

and results in a frequency shift by a value of Δf. This phase modulation can be applied in the transmitter modulator simultaneously and in addition to the data modulation. Instead of modulation of a complex modulation value

$$m ( t ) = a ( t ) \cdot exp [ j \cdot ϕ ( t ) ] ,$$

a modulation value of

$${m}^{′} ( t ) = m ( t ) \cdot exp [ j \cdot {ϕ}_{mod} ( t ) ]$$

is applied. A modulator bandwidth of ca. 30 GHz for a 50 GBd signal may be favorable.

### LIST OF ABBREVIATIONS

ADC analog-to-digital converter
CO central office
DS downstream
DSP digital signal processor
LO local oscillator
ODN optical distribution network
OLT optical network termination
ONU optical networking unit
ORL optical return loss
PON passive optical network
P_{TX1} transmission power of signal transmitted from OLT to ONT
P_{TX2} transmission power of signal transmitted from ONT to OLT
TDMA time-division multiple access
TFDMA time-frequency division multiple access
TIA transimpedance amplifier
US upstream

What is claimed is:

1. A method for processing optical signals, comprising:
deriving both of a mixing signal and a transmission carrier from a single light source,
wherein the mixing signal is located within a frequency band of a received signal and/or wherein the transmission carrier is located within the frequency band of the transmission signal.

2. The method according to claim 1, wherein the single light source comprises a laser or a laser diode.

3. The method of claim 1, wherein the method is operated by an optical transceiver.

4. The method of claim 1, wherein the mixing signal corresponds to or is based on a local oscillator for receiving signals.

5. The method of claim 1, wherein the mixing signal and a transmission carrier are separated by a fixed frequency.

6. The method of claim 1, wherein the received signal is low pass filtered in an electrical domain.

7. The method of claim 1, wherein the frequency of the transmission carrier is adjusted based on an offset between the frequency of the mixing signal and a center frequency of the received signal.

8. The method of claim 1, wherein deriving both of the mixing signal and the transmission carrier from a single light comprises one of the following:
obtaining a frequency shift by a phase slope modulation over time; and
determining the frequency shift using the transmission carrier;
generating the mixing signal and the transmission carrier by modulation through a signal with a frequency amounting to a frequency shift Δf or a sub-harmonic thereof;
obtaining the mixing signal and the transmission carrier via an I-Q-modulator utilizing a phase-slope modulation corresponding to half the desired frequency shift value; and
obtaining the mixing signal and the transmission carrier via a comb laser structure.

9. An optical transceiver comprising:
a transmitter configured to transmit optical signals,
a receiver configured to receive optical signals,
a single light source that is utilized for a mixing signal and a transmission carrier, wherein the mixing signal is located within a frequency band of a received signal and/or wherein the transmission carrier is located within the frequency band of the transmission signal.

10. The optical transceiver according to claim 9, wherein the transceiver is located in an optical network component, in particular in an OLT or an ONU.

11. A device for processing optical signals, comprising a processing unit that is arranged to perform operations comprising:
deriving both of a mixing signal and a transmission carrier from a single light source,
wherein the mixing signal is located within a frequency band of a received signal and/or wherein the transmission carrier is located within the frequency band of the transmission signal.

12. The device according to claim 11, wherein the device is, or is part of, an optical line terminal or an optical network unit.

13. The device of claim 11, wherein the single light source comprises a laser or a laser diode.

14. The device of claim 11, further comprising an optical transceiver configured to perform the operations.

15. The device of claim 11, wherein the mixing signal corresponds to, or is based on, a local oscillator for receiving signals.

16. The device of claim 11, wherein the mixing signal and a transmission carrier are separated by a fixed frequency.

17. The device of claim 11, wherein the received signal is low pass filtered in an electrical domain.

18. The device of claim 11, wherein the frequency of the transmission carrier is adjusted based on an offset between the frequency of the mixing signal and a center frequency of the received signal.

19. The device of claim 11, wherein deriving both of the mixing signal and the transmission carrier from a single light comprises one of the following:
obtaining a frequency shift by a phase slope modulation over time; and
determining the frequency shift using the transmission carrier;
generating the mixing signal and the transmission carrier by modulation through a signal with a frequency amounting to a frequency shift Δf or a sub-harmonic thereof;
obtaining the mixing signal and the transmission carrier via an I-Q-modulator utilizing a phase-slope modulation corresponding to half the desired frequency shift value; and
obtaining the mixing signal and the transmission carrier via a comb laser structure.
